(19) United States
(12) Patent Application Publication
(10) Pub. No.: US 2006/0293620 A1
(43) Pub. Date: Dec. 28, 2006

(54) Massaging footrest

(76) Inventor: Denis Viger, Magog (CA)

Correspondence Address: GEORGE A. SEABY;SEABY & ASSOCIATES, 250 CITY CENTRE AVNUE, OTTAWA, ON, K1R6K7, CA

(21) Appl. No.: 11/447,890

(22) Filed: Jun. 7, 2006

Related U.S. Application Data
(60) Provisional application No. 60/688,370, filed on Jun. 8, 2005.

(51) Int. Cl. A61H 7/00

(52) U.S. Cl. 601/148

(57) ABSTRACT

A massage apparatus, which can be retrofitted to a footrest includes vibrators for mounting on the bottom of the footrest; a generally U-shaped frame; hinges for pivotally connecting the footrest to the frame; and a switch on the frame which is in the open position when the footrest lies against the frame and in the closed position when the footrest is rotated relative to the frame to the open, use position. Closing of the switch results in actuation of the vibrators. By placing the feet against the vibrators, the user gets a foot massage.

### CROSS-REFERENCE TO RELATED APPLICATIONS

This application claims the benefit of US Provisional Application No. 60/688,370, filed Jun. 8, 2005.

### BACKGROUND OF THE INVENTION

1. Field of the Invention

This invention relates to a foot massage apparatus, and to a footrest with a built-in foot massager.

2. Discussion of the Prior Art

There are many different recliners available in the marketplace. Many recliners include built-in massage devices. Examples of such chairs are described in U.S. Pat. No. 2,937,641, issued to N. Oetinger on May 24, 1960; U.S. Pat. No. 3,092,100, issued to N. Oetinger on Jun. 4, 1963; U.S. Pat. No. 3,948,379, issued to H. J. Warner on Apr. 6, 1976; U.S. Pat. No. 5,713,832, issued to A. S. Jain on Feb. 3, 1998; U.S. Pat. No. 5,813,727, issued to A. Sugawa et al on Sep. 29, 1998 and U.S. Pat. No. 6,592,533, issued to M. Yonekawa et al on Jul. 15, 2003. In general, massage devices are built into the recliners during manufacture thereof. The resulting chairs are somewhat complicated in terms of structure and consequently expensive to produce. Moreover, the footrests disclosed by these patents are adapted to massage the back of a user's legs rather than the feet. While it would be a desirable addition to such chairs, the inventor is not aware of any recliners with built-in foot massagers.

### GENERAL DESCRIPTION OF THE INVENTION

An object of the present invention is to meet the above defined need by providing a relatively simple massage apparatus for use in a footrest with a built-in foot massager.

Another object of the invention is to provide a foot massage apparatus, which can be retrofitted to existing footrests.

Accordingly, the invention relates to a foot massage apparatus for use on a footrest having a base and a cover comprising at least one vibrator for mounting on the bottom of the footrest base, a frame for connecting the footrest base to an article of furniture; hinge means for pivotally connecting the footrest base to the frame, whereby the footrest can be rotated between a closed position against the frame and an open position, in which said at least one vibrator is accessible to a user; and a switch on said frame connected to a source of electrical current and to said at least one vibrator, said switch being normally held open by the footrest base in the closed position and closed when the footrest base is rotated to the open position to actuate said at least one vibrator.

### BRIEF DESCRIPTION OF THE DRAWINGS

The invention is described below in greater detail with reference to the accompanying drawings, wherein:

FIG. 1 is an isometric view of a preferred embodiment of a foot massage apparatus in accordance with the present invention in the closed position;

FIG. 2 is an isometric view of the apparatus of FIG. 1 in the open, use position;

FIG. 3 is an isometric view of a spring assembly used in the apparatus of FIGS. 1 and 2;

FIG. 4 is an isometric view of a second embodiment of the massage apparatus in the open, use position;

FIG. 5 is a side view of the apparatus of FIG. 4; and

FIG. 6 is a side view of one end of the apparatus of FIGS. 4 and 5 as seen from the side opposite that shown in FIG. 5.

### DESCRIPTION OF THE PREFERRED EMBODIMENT

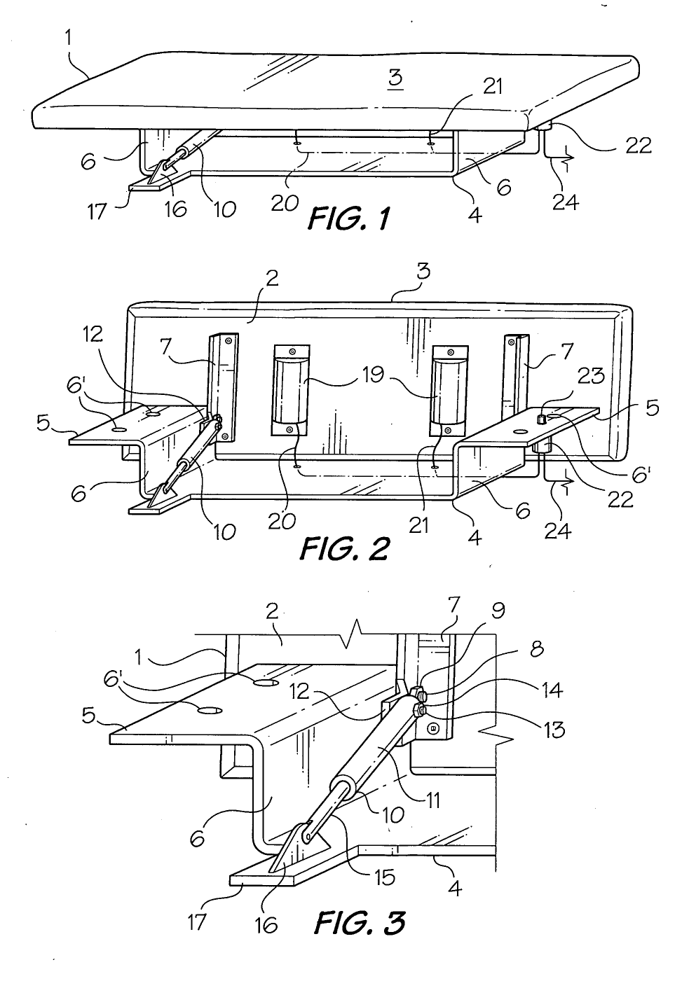

With reference to FIGS. 1 and 2, the massage apparatus of the present invention is intended for use with a conventional footrest 1, which includes a rigid base 2 and a padded top or cover 3. In accordance with the invention, the base 2 is pivotally connected to a generally U-shaped metal frame 4 by a hinge for rotation between a closed, footrest position (FIG. 1) and an open massage position (FIG. 2).

In the closed position, the baseplate 2 of the footrest 1 rests on ledges or arms 5 extending outwardly from the vertical ends 6 of the frame 4. Holes 6′ are provided in the ledges 5 for receiving screws, bolts or rivets (not shown) to connect the footrest and massage apparatus to an article of furniture, i.e. a chair or sofa. The hinge includes angle irons 7 connected to the bottom of the baseplate 2. The angle irons 7 and consequently the base 2 are pivotally connected to the ends 6 of the frame 4 by bolts 8 and nuts 9 (one of each shown in FIGS. 2 and 3). As best shown in FIG. 3, a spring assembly 10 extends between one of the angle irons 7 and the frame 4. The spring assembly 9 includes a cylinder 11 containing a spring (not shown). The top end of the cylinder 11 is pivotally connected to an outwardly extending arm 12 on one end of the angle iron 7 by a bolt 13 and a nut 14. The bottom end of a piston rod 15 extending out of the cylinder 11 is pivotally connected to a triangular lug 16 extending upwardly from a ledge 17 at one end of the frame 4. The spring assembly 10 could also be a fluid containing cylinder, e.g. an air cylinder. The spring assembly 10 slows the opening and closing of the footrest 1, i.e. smooths movement of the footrest 1 between the open and closed positions.

Two vibrators 19 are mounted on the bottom surface of the baseplate 2, so that when the footrest is opened the vibrators are exposed for massaging a person's feet. Wires 20 and 21 connect the vibrators 19 to a microswitch 22 mounted beneath one of the ledges 5 of the frame 4. The plunger 23 for opening and closing the switch 22 extends upwardly through a hole in the ledge 5. Thus, when the footrest is closed, the microswitch 22 is also closed, and when the footrest is opened, the switch is also open to activate the vibrators 19. A wire 24 connects the microswitch 22 to a source of electrical power (not shown) which can be built into a chair or sofa carrying the footrest.

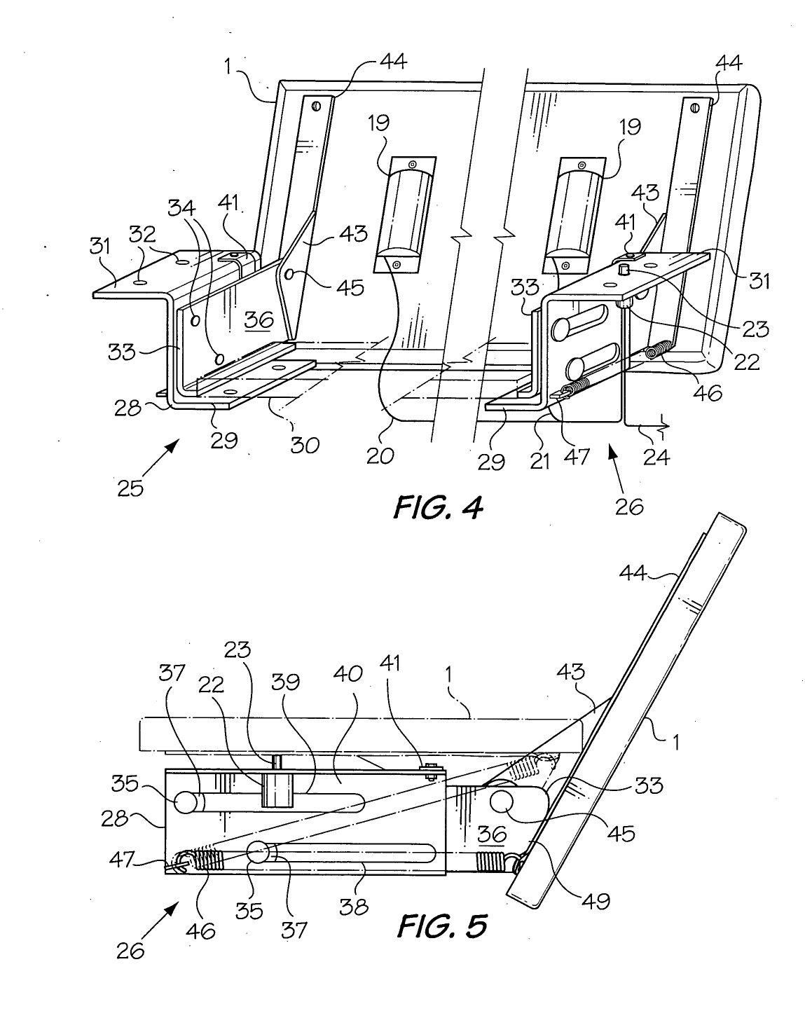

In the following description of a second embodiment of the invention, wherever possible the reference numerals used in FIGS. 1 to 3 have been used to identify the same or similar elements in FIGS. 4 to 6.

The apparatus of FIGS. 4 to 6 can be adapted to footrests 1 of varying lengths. For such purpose, the apparatus has a frame including a pair of end bracket assemblies indicated generally at 25 and 26 which are mirror images of each other. Each of the bracket assemblies 25 and 26 includes a generally S-shaped bracket 28 having a bottom ledge 29 for supporting one end of a board 30. The length of the board 30 will depend upon the length of the footrest, i.e. the apparatus can readily be adapted to existing footrests having different dimensions. Thus, the bracket assemblies 25 and 26, and the board 30 define the frame of the apparatus. The top, outwardly extending arm or ledge 31 of the bracket assembly 26 supports a microswitch 22 for opening when the footrest 1 is opened to actuate a pair of vibrators 19 mounted on the bottom of the footrest. As in the apparatus of FIGS. 1 to 3, the vibrators 19 are connected to the microswitch 22 by wires 20 and 21, and the microswitch is connected to a source of power by a wire 24 (the wires 20, 21 and 24 being shown in FIG. 4 only). Holes 32 are provided in the ledges 31 for connecting the apparatus to a chair or sofa (not shown).

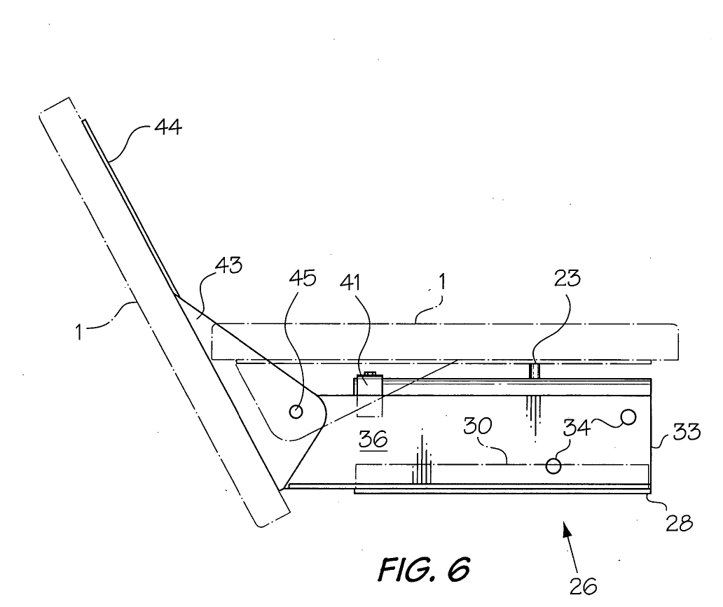

As best shown in FIGS. 5 and 6 each of the bracket assemblies 25 and 26 supports a generally L-shaped slide 33. Pins 34 with large heads 35 extend from the vertical arm 36 of the slide 33 through washers 37 between the slide 33 and the bracket 28, and through a pair of horizontal slots 38 and 39 in the vertical web 40 of the bracket 28. The vertical arm of an inverted L-shaped bushing 41 mounted on the rear end of the bracket 28 extends downwardly between the slide 33 and the bracket. Thus, the slides 33, which carry the footrest 1 can be slid relative to the brackets 28 for accommodating different users, i.e. people with longer or shorter legs. The generally triangular arms 43 of hinges 44 connected to the bottom of the footrest 1 are pivotally connected to the rear or outer ends of the slides 33 by pins 45 for rotation between the open and closed positions shown in solid lines and in phantom outline, respectively in FIG. 5. A helical spring 46 extends between a lug or ear 47 on the bottom front end of the bracket 28 and the outer, bottom end of the footrest 1 for biasing the footrest to the closed position (shown in phantom outline in FIG. 5) The outer end 49 of each slide 33 is inclined and acts as a stop for limiting rotation of the footrest in the open position. When the footrest is moved to the open position, the hinge 44 butts against the outer end 49 of the slides 33 to maintain the footrest in the inclined, use position.

The use of the apparatus of FIGS. 4 to 6 is the same as that of FIGS. 1 to 3. When the footrest is pivoted from the closed to the open position, the microswitch 22 opens to actuate the vibrators 19. The user presses his/her feet against the vibrators 19 for a foot massage. The slides 33 permit adjustment of the position of the footrest 1 relative to the board 30, which is attached to the brackets 28 and consequently fixed with respect to the chair or sofa carrying the footrest apparatus.

1. A foot massage apparatus for use on a footrest having a base and a cover comprising at least one vibrator for mounting on the bottom of the footrest base, a frame for connecting the footrest base to an article of furniture; hinge means for pivotally connecting the footrest base to the frame, whereby the footrest can be rotated between a closed position against the frame and an open position, in which said at least one vibrator is accessible to a user; and a switch on said frame connected to a source of electrical current and to said at least one vibrator, said switch being normally held open by the footrest base in the closed position and closed when the footrest base is rotated to the open position to actuate said at least one vibrator.

2. The foot massage apparatus of claim 1, wherein said frame is U-shaped and includes a ledge on the top of each end thereof for use in connecting the frame to an article of furniture; said at least one vibrator being located between the ends of the frame in the closed position of the footrest.

3. The foot massage apparatus of claim 1 including spring means extending between said frame and said base of the footrest for biasing said footrest to the closed position.

4. The foot massage apparatus of claim 2, wherein said switch means is mounted beneath one said ledge and includes a plunger extending upwardly through the ledge into contact with said footrest in the open position.

5. The foot massage apparatus of claim 1, wherein said frame includes a pair of spaced apart brackets for connection to an article of furniture, slides mounted on said brackets for movement toward and away from the article of furniture, and a baseplate extending between said slides, said hinge means pivotally connecting said footrest base to outer free ends of said slides.
